(19) United States
(12) Patent Application Publication
(10) Pub. No.: US 2012/0066322 A1
(43) Pub. Date: Mar. 15, 2012

(54) COMPUTER-NETWORK-BASED SYSTEM AND METHODOLOGY FOR ENHANCING PERSONAL-INFORMATION STORAGE AND TRANSFER CONTROL

(75) Inventors: Tzu-Chieh Yang, Portland, OR (US); Peter M. Galen, Portland, OR (US); Norman S. Kato, Los Angeles, CA (US)

(73) Assignee: Veragen, Inc., Portland, OR (US)

(21) Appl. No.: 13/232,987

(22) Filed: Sep. 14, 2011

Related U.S. Application Data
(60) Provisional application No. 61/383,316, filed on Sep. 15, 2010.

(51) Int. Cl. G06F 15/16

(52) U.S. Cl. 709/206; 709/217

(57) ABSTRACT

A computer-network-based methodology and system for enhancing user control over the storage and transfer of user-personal information data in a network setting which includes both control-distant and control-near, information-data storage sites, and where user-personal information data which the user wishes to move may be held in the control-distant storage site. The methodology, implemented by the associated system, features enabling direct, user-control-access to any user-personal information data which is held in the control-distant storage site, and following such enabling, and under direct user-permitted command, promoting user-command transfer of at least a selected portion of the user-personal information data which is held in the control-distant storage site from the control-distant storage site to the control-near storage site.

### CROSS REFERENCE TO RELATED APPLICATION

This application claims filing-date priority to U.S. Provisional Patent Application, Ser. No. 61/383,316, filed Sep. 15, 2010, for “Computer-Based Cloud, E-Mail, and Other Information Storage and Transfer Control”, the entire disclosure content in which is hereby incorporated herein by reference.

### BACKGROUND AND SUMMARY OF THE INVENTION

This invention involves systemic and methodologic approaches that are employable, conveniently and efficiently, to enable several useful forms of information data “to and from” storage and transfer control in various network and computer environments, including (but not limited to) both the e-mail and the so-called cloud-computing environments. Put another way, the present invention pertains to a computer-network-based system, and an associated methodology, for enhancing user control over the storage and transfer of personal information data in a network setting which includes both what are referred to herein as “control-distant” and as “control-near” information-data storage sites, under circumstances where user-personal information data which the user wishes to move may, before a user-requested transfer move has occurred, be held in a control-distant storage site.

The terms “control-distant” and “control-near” do not refer to physical distances. Rather, and generally speaking as will now be explained, the term “control-distant”, as applied to an information-data storage site, is intended herein to refer both (1) to storage-site structure which is somewhat less than easily convenient to, or under the control of, a user, as well as (2) to such a site which is more or less under the direct control of another entity, such as might be the case with a cloud storage site under the direct control of the cloud provider of such a site. The term “control-near”, as applied to an information-data storage site, is intended herein to refer to any information-data storage (or other kind of data reception and handling) site which is under very direct control, or nearly so, of the user, and which, because of this condition, is more readily and easily employable and controllable by a user.

In certain, special cases involving the intended transmission by e-mail, from one's own computer to another computer, of very large files which may be too large for direct, full-file, conventional e-mail transmission, and to avoid, say, having to transmit, instead of using e-mail, a link to such a file to the “cloud” for subsequent “link-downloading” by the intended recipient party at the site of that party's recipient computer, the present invention specifically contemplates actually handling such a file, by e-mail, but in specifically user-determined/defined, smaller pieces. In this special, data-management kind of case, one's own computer is considered herein to be a “control-distant” site, and the intended, recipient computer to be a “control-near” site.

We believe that these two “control, etc.” terms, and their practical scopes, given the general definitions for them just to set forth above, will be clearly understandable by those skilled in the art of network data storage, data transfer and data management.

The present invention has been formed in the setting of the wide number of options that are available today for the generation, management and storage of data—a setting which may, and often does, present users with situations in which some (or all) of their personal data (also referred to herein as information data) is, or may be, stored “distantly”, and therefore perhaps not fully under their control, and regarding which they may desire, for many different purposes, and under such circumstances, to move from one location to another, and/or exert increased personal control over, their owned, personal information data.

The features of the present invention particularly address this world of personal information-data storage and transfer control, and very specifically, address several special ways, in different settings, in which a user may implement enhanced personal information-data control.

As will be more detailedly discussed below, the drawing figures which form parts of the present invention disclosure generally illustrate several of these settings in which the features and practices of the present invention offer particularly utility. These features and practices, as suggested above, are focused on the field of personal information storage and transfer control involving, among other things, (1) the so-called cloud, (2) the world of e-mail, and (3) computer-to-computer and server-to-server, etc., data movements.

By way of certain background information, and beginning with realm of “the cloud”, so-called cloud computing has become a widespread practice respecting remote invocations, and distant uses, of various computer applications, and the related, remote, cloud storage of data, utilizing an extensive, communication network, such as the Internet. It is typical that what may be thought of as cloud-computing applications and storage structures, environments and practices, etc., are owned by parties who/which do not necessarily own the data that is cloud-application-generated and/or stored in a cloud-storage setting. User-owners of such data, and access to applications for creating data are, of course, readily available to such users, and the present invention concerns, as already mentioned, additional, user-accessible practices which may be implemented by users/owners of data to move that data, and files associated with it, to other kinds of storage (or other character) locations which are more directly electronically under the ownership/control of the users, per se.

Thus, in very general terms, the present invention involves a system and a methodology enabling direct request by a user for the moving of various forms of currently storage-held, user-owned data/information—the holding of which may either not be under the direct control of that user, or may be existing in some location less desirable or convenient to the user—via e-mail, or some other mode, to what may be thought of as a post-current, more electronically proximate and individually more controlled, convenient, etc. environment.

From a structural point of view, what is proposed by the present invention is a computer-network-based system for promoting enhanced user control over the storage and transfer of user-personal information data including (a) a control-distant information-data storage site which holds user-personal information data which the user wishes to move, (b) a control-near information-data storage site, (c) an operative and implementable network-communication connection in place between the control-distant and the control-near information-data storage sites, and (d) a user-command site operatively and communicatively connected to each of the information-data storage sites enabling a direct user command promoting the transfer from the control-distant storage site to the control-near storage site, and over the operative and implementable network-communication connection which is in place between the two, information-data storage sites, of at least a selected portion of the user-personal information data which is held in the control-distant storage site.

Methodologically, what is proposed is a computer-network-based methodology for enhancing user control over the storage and transfer of user-personal information data in a network setting which includes both control-distant and control-near, information-data storage sites, and where user-personal information data which the user wishes to move may be held in the control-distant storage site, this methodology including (a) enabling direct, user-control-access to any user-personal information data which is held in the control-distant storage site, and (b) following such enabling, and under direct user-permitted command, promoting user-command transfer of at least a selected portion of the user-personal information data which is held in the control-distant storage site from the control-distant storage site to the control-near storage site.

The other features and advantages that are offered by the present invention will become more fully apparent as the detailed description of it which follows below is read in conjunction with the accompanying drawings.

### DESCRIPTIONS OF THE DRAWINGS

FIG. 1 presents a high-level, block/schematic, network diagram generally illustrating the overall concept and practice of the present invention.

FIG. 2 is a high-level, block/schematic, net work illustration picturing a user's request issued as a command from a user-command site for the e-mail transfer movement of user-personal information data, which may exist in a very large file (perhaps too large for direct e-mail transmission), from a control-distant cloud server and its associated storage structure, and in user-selected and user-size-determined, smaller e-mail pieces, to a control-near, user/owner-controlled, reception/site which functions as a reassembly site with regard to reassembly and storage (or other end result) of the e-mail file pieces that are illustrated representatively in this figure.

FIG. 3 is a high-level, block/schematic, network diagram illustrating employment of the data transfer-enhancement features of the present invention for selective, user-personal information data transfer from a control-distant cloud application and its associated storage structure, to a control-near, user owned/controlled, cloud storage structure.

FIG. 4 is a high-level, block/schematic illustration, somewhat similar to that presented in FIG. 2, showing user-commanded, user-personal, very large file (again, perhaps too large for direct e-mail transmission) information-moving, in user-selected and user-size-determined, smaller e-mail pieces, from a control-distant network-connected computer, which might well be the transmitting user's own computer (as explained above to be in a special category of information-data-transfer cases) to some other, appropriate, user-selected, control-near reception site, such as another network-connected computer belonging to an intended recipient party.

### DETAILED DESCRIPTION OF THE INVENTION

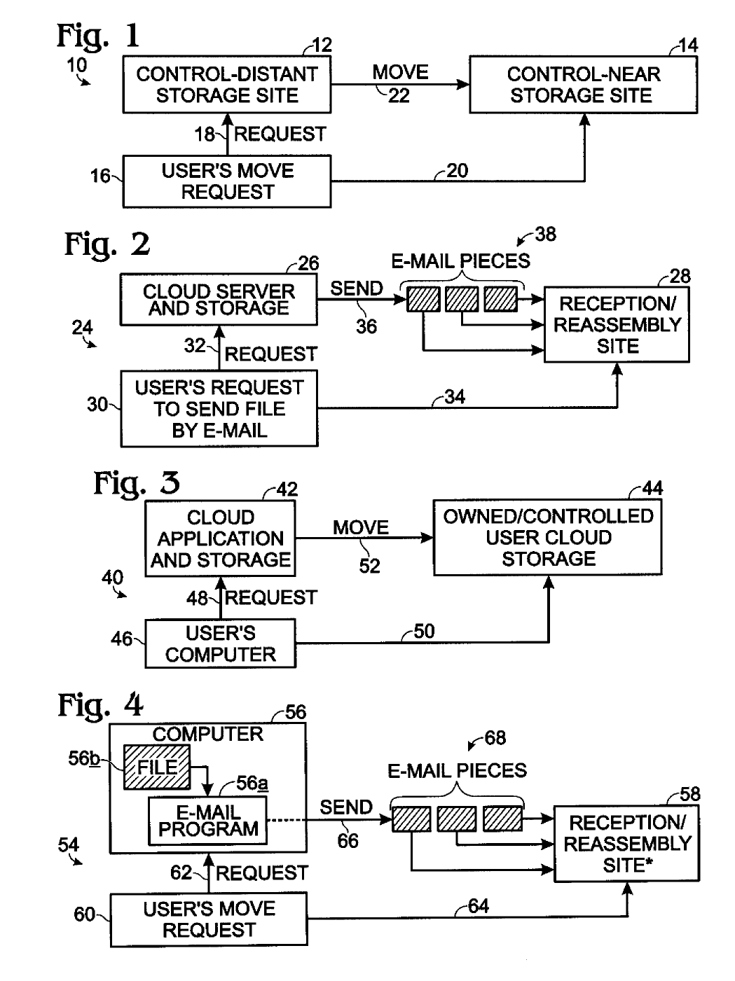

Turning now to the drawing figures, what we point out first of all herein is that each of these figures may be viewed as illustrating both the network-systemic and network-methodologic features of the present invention, with FIG. 1 presenting such an illustration in a very general manner, and FIGS. 2-4, inclusive, illustrating, respectively, different, specific, structural and methodologic implementations of the invention. Accordingly, and as will now, and below, be pointed out, in each of these four drawing figures, there are three, principal schematic blocks, generally labeled differently in each of the four figures, which three function as the basic operative blocks of the system and methodology of the invention—these blocks constituting (a) a “control-distant”, information-data storage site, (b) a “control-near”, information-data storage site, and (c) a “user-command” site.

Thus, indicated generally at 10 in FIG. 1 is a computer-network-based system and methodology constructed in accordance with a preferred and best-mode implementation of the present invention. Speaking now, for simplicity's sake, in systemic terms, included in system 10 are a control-distant, information-data storage site 12, specifically labeled “Control-Distant Storage Site”, a control-near, information-data storage site 14, specifically labeled “Control-Near Storage Site”, and a user-command site 16. User-command site 16, specifically labeled “User's Move Request”, is operatively, network-connected to sites 12, 14 by appropriate, operative, network-data-flow connections illustrated, respectively, by arrow-headed lines 18, 20. An arrow-headed line 22 shown extending between sites 12, 14 constitutes what is referred to herein as an operative and implementable network-communication connection between the two information-data storage sites 12, 14.

Line (network-data-flow connection) 18, next to which appears the word “Request”, functions to convey from site 16 to site 12 a user's command to move from site 12 to site 14 at least a portion of the user-personal information data which is stored in the storage structure included in site 12. Line (network-communication connection) 22, next to which appears the word “Move”, functions, in response to such a user command, to transfer the appropriate, transfer-commanded, user-personal information data from site 12 to site 14.

Indicated generally at 24 in FIG. 2 is another computer-network-based system and methodology constructed in accordance with a specific implementation of the present invention involving, ultimately, the commanded transfer of user-personal information data contained in a large file (too big for normal e-mail transfer) from the storage structure which is associated with a cloud server, via appropriately sized, small, e-mail pieces, to a reception/reassembly site, much in a manner patterned on that which is illustrated in the generally pictured and described network setting shown in FIG. 1.

Again speaking simply in systemic terms, included in system and methodology 24 are a control-distant, information-data storage site 26, specifically labeled “Cloud Server and Storage”, a control-near, information-data storage site 28, specifically labeled “Reception/Reassembly Site”, and a user-command site 30. User-command site 30, specifically labeled “User's Request To Send File By E-mail”, is operatively, network-connected to sites 26, 28, by appropriate, operative, network-data-flow connections illustrated, respectively, by arrow-headed lines 32, 34. An arrow-headed line 36 shown extending, just partially as will be explained, between sites 26, 28 constitutes an operative and implementable network-communication connection between the two information-data storage sites 26, 28. The partial showing of connection 36 accommodates an illustrative, schematic interruption to picture three, representative e-mail, information-data transfer pieces, bracketed and so labeled, and collectively designated 38.

Line (network-data-flow connection) 32, next to which appears the word “Request”, functions to convey from site 30 to site 26 a user's command to move by e-mail, from site 26 to site 28, at least a portion of the user-personal information data which is stored in the storage structure included in site 26. Line (network-communication connection) 36, next to which appears the word “Send”, functions, in response to such a user command, to transfer, by e-mail pieces, the appropriate, transfer-commanded, user-personal information data from site 26 to site 28.

Turning attention now to FIG. 3, shown generally at 40 in this figure is yet another computer-network-based system and methodology constructed in accordance with still another, specific implementation of the present invention involving, ultimately, the commanded transfer of user-personal information data from the storage structure which is associated with a cloud application to a user owned/controlled cloud storage site.

Speaking once more simply in systemic terms, included in system and methodology 40 are a control-distant, information-data storage site 42, specifically labeled “Cloud Application and Storage”, a control-near, information-data storage site 44, specifically labeled “Owned/Controlled User Cloud Storage”, and a user-command site 46. User-command site 46, which is specifically labeled “User's Computer”, is operatively, network-connected to sites 42, 44, by appropriate, operative, network-data-flow connections illustrated, respectively, by arrow-headed lines 48, 50. An arrow-headed line 52, shown extending between sites 42, 44, constitutes an operative and implementable network-communication connection between the two information-data storage sites 42, 44.

Line (network-data-flow connection) 48, next to which appears the word “Request”, functions to convey from site 46 to site 42 a user's command to move at least a portion of the user-personal information data which is stored in the storage structure associated with the cloud application of site 42. Line (network-communication connection) 52, next to which appears the word “Move”, functions, in response to such a user command, to transfer the appropriate, transfer-commanded, user-personal information data from site 42 to site 44.

FIG. 4 pictures generally 54 one more computer-network-based system and methodology constructed in accordance with a still further, specific, and special-case, implementation of the present invention involving, ultimately, the commanded transfer of user-personal information data, existing in a large file (too large for conventional e-mail transmission), from the storage structure which is associated with a computer (which may be the transferring user's own computer), via appropriately user-selected-downsized e-mail pieces, to a reception/reassembly site (a receiving computer site), much in a manner patterned on that which is illustrated in FIG. 2.

In systemic terms, included in system and methodology 54 are a control-distant, information-data storage site 56, specifically labeled “Computer”, a control-near, information-data storage site 58, specifically labeled “Reception/Reassembly Site”, and a user-command site 60. Drawn within site block 56 are an E-mail Program 56a and a representative block 56b of user-personal information data, labeled “File” (the “overly large” file), which is to be user-command transferred in small, “e-mail-possible” pieces.

User-command site 60, labeled “User's Move Request”, is operatively, network-connected to sites 56, 58, by appropriate, operative, network-data-flow connections illustrated, respectively, by arrow-headed lines 62, 34. An arrow-headed line 66 shown extending, just partially as will be explained, between sites 56, 58 forms an operative and implementable network-communication connection between the two information-data storage sites 56, 58. The partial showing of connection 66, as is similarly the case in what appears in FIG. 2, accommodates an illustrative, schematic interruption to picture three, representative e-mail, information-data transfer pieces, bracketed and so labeled, and collectively designated 68.

Line (network-data-flow connection) 62, next to which appears the word “Request”, functions to convey from site 60 to site 56 a user's command to move by e-mail (via E-mail Program 56a), from site 56 to site 58, at least a portion (File 56b) of the user-personal information data which is stored in the storage structure included in computer site 56. Line (network-communication connection) 66, next to which appears the word “Send”, functions, in response to such a user command, to transfer, by e-mail pieces, the appropriate, transfer-commanded, user-personal information data from site 56 to site 58.

Thus, the present invention proposes and offers a computer-network-based methodology for enhancing user control, in various ways, over the storage and transfer of user-personal information data in a network setting which includes both control-distant and control-near, information-data storage sites, and where user-personal information data which the user wishes to move may be held in the control-distant storage site. Generally speaking, this methodology features enabling direct, user-control-access to any user-personal information data which is held in the control-distant storage site, and following that enabling, and under direct user-permitted command, promoting transfer of at least a selected portion of the user-personal information data which is held in the control-distant storage site from the control-distant storage site to the control-near storage site.

The methodology is specifically employable in a network setting wherein the control-distant storage site which holds the user-personal information data is one of (a) a cloud server and its associated storage structure, (b) a cloud application and its associated storage structure, and (c) a network-connected computer and its associated storage structure. The network setting is also one wherein the control-near storage site which is to receive the user-transferred, user-personal information data is a readily user-accessible one of (a) a user-owned/controlled cloud storage structure, (b) a user owned/controlled, computer-based, network-connected reception structure of any structural nature, (c) a user-accessible network-connected server, and (d) a user-accessible structure of an e-mail program. Execution of a user command to move data may take place in the form of the sending of one or more re-assembleable e-mail piece(s).

The methodology of the invention, as described and illustrated, is implemented in a computer-network-based system which includes a control-distant information-data storage site which holds user-personal information data which the user wishes to move, a control-near information-data storage site, an operative and implementable network-communication connection in place between the control-distant and the control-near information-data storage sites, and a user-command site operatively and communicatively connected to each of the two, information-data storage sites enabling a direct user command promoting the transfer from the control-distant storage site to the control-near storage site, over the operative and implementable network-communication connection which is in place between the information-data storage sites, of at least a selected portion of the user-personal information data which is held in the control-distant storage site.

The control-distant storage site is preferably a user-accessible one of (a) a cloud server and associated storage structure, (b) a cloud application and associated storage structure, and (c) a network-connected computer and its associated storage structure. The control-near storage site is preferably a user-accessible one of (a) a user-owned/controlled cloud storage structure, (b) a user owned/controlled, computer-based, network-connected reception structure of any structural nature, (c) a user-accessible network-connected server, and (d) a user-accessible structure of an e-mail program.

It will be recalled that the methodology, and the systemic structure, of the invention take into account the special e-mail-piece-transfer practice discussed specifically in relation to FIGS. 2 and 4.

It should be understood that, with respect to the features of the methodology and the system of the present invention as described and illustrated herein, in addition to the several, specific kinds of control-distant and control-near information-data storage sites which have been described, there may well be other specific kinds of such sites which fit well within the site definitions expressed above, and it is our intention that all such other kinds of functionally similar sites be recognized as being included within the scope of the present invention. Additionally, it is very important to understand that practice and implementation of the present invention fully recognizes, and does not challenge, the value and importance, in many instances, for users to have available to them, and to employ for categories of personal-information data storage, so-called control-distant information-data storage sites. Rather, the features of the present invention simply offer enhanced ways to take advantage of such control-distant sites, in a manner which freely permits, as desired by a user, the command transfer, to what has been defined herein as a control-near information-data storage site, of all or a portion of personal information stored at the location of such a site. In other words, an important focus of the present invention is to offer a significant new network option to a user for managing the storage and transfer of personal information in a manner which best suits the convenience of that user.

Accordingly, while preferred and best-mode embodiments of, and manners of practicing, the present invention have been specifically discussed herein, we fully appreciate that those generally skilled in the relevant art may perceive useful variations and modifications which will come within the scope of the appended claims.

We claim:

1. Computer-network-based methodology for enhancing user control over the storage and transfer of user-personal information data in a network setting which includes both control-distant and control-near, information-data storage sites, and where user-personal information data which the user wishes to move may be held in the control-distant storage site, said methodology comprising
enabling direct, user-control-access to any user-personal information data which is held in the control-distant storage site, and
following said enabling, and under direct user-permitted command, promoting user-command transfer of at least a selected portion of the user-personal information data which is held in the control-distant storage site from the control-distant storage site to the control-near storage site.

2. The methodology of claim 1 which is specifically employable in a network setting wherein the control-distant storage site which holds the user-personal information data that is subject user transfer control in relation to said enabling step is one of (a) a cloud server and its associated storage structure, (b) a cloud application and its associated storage structure, and (c) a network-connected computer and its associated storage structure.

3. The methodology of claim 1 which is specifically employable in a network setting wherein the control-near storage site which is to receive the user-transferred, user-personal information data is a readily user-accessible one of (a) a user-owned/controlled cloud storage structure, (b) a user owned/controlled, computer-based, network-connected reception structure of any structural nature, (c) a user-accessible network-connected server, and (d) a user-accessible structure of an e-mail program.

4. The methodology of claim 2 which, further, is specifically employable in a network setting wherein the control-near storage site which is to receive the user-transferred, user-personal information data is a user-accessible one of (a) a user-owned/controlled cloud storage structure, (b) a user owned/controlled, computer-based, network-connected reception structure of any structural nature, (c) a user-accessible network-connected server, and (d) a user-accessible structure of an e-mail program.

5. The methodology of claim 1, wherein the user-command site is structured to enable the execution of a user command to move at least a selected portion of user-personal information data in the form of one or more re-assembleable e-mail piece(s).

6. A computer-network-based system for promoting enhanced user control over the storage and transfer of user-personal information data comprising
a control-distant information-data storage site which holds user-personal information data which the user wishes to move,
a control-near information-data storage site,
an operative and implementable network-communication connection in place between said control-distant and said control-near information-data storage sites, and
a user-command site operatively and communicatively connected to each of said information-data storage sites enabling a direct user command promoting the transfer from the control-distant storage site to the control-near storage site, and over said operative and implementable network-communication connection which is in place between said information-data storage sites, of at least a selected portion of the user-personal information data which is held in the control-distant storage site.

7. The system of claim 6, wherein said control-distant information-data storage site is a user-accessible one of (a) a cloud server and associated storage structure, (b) a cloud application and associated storage structure, and (c) a network-connected computer and its associated storage structure.

8. The system of claim 6, wherein said control-near information-data storage site is a user-accessible one of (a) a user-owned/controlled cloud storage structure, (b) a user owned/controlled, computer-based, network-connected reception structure of any structural nature, (c) a user-accessible network-connected server, and (d) a user-accessible structure of an e-mail program.

9. The system of claim 7, wherein said control-near information-data storage site is a user-accessible one of (a) a user-owned/controlled cloud storage structure, (b) a user owned/controlled, computer-based, network-connected reception structure of any structural nature, (c) a user-accessible network-connected server, and (d) a user-accessible structure of an e-mail program.

10. The system of claim 7, wherein said user owned/controlled, computer-based, network-connected reception structure takes the form of an e-mail-piece reassembly structure.

11. The system of claim 6, wherein said promoting of user-command transfer of at least a selected portion of the user-personal information data specifically promotes information-data movement in the form of one or more re-assembleable e-mail piece(s).
